(19) United States
(12) Patent Application Publication
(10) Pub. No.: US 2007/0064843 A1
(43) Pub. Date: Mar. 22, 2007

(54) Method and system for mobile cellular television tuner utilizing current-steering variable gain at RF

(76) Inventors: Konstantinos D. Vavelidis, Ilioupolis (GR); Aristeidis I. Kyranas, Zografou (GR)

Correspondence Address: MCANDREWS HELD & MALLOY, LTD, 500 WEST MADISON STREET, SUITE 3400, CHICAGO, IL, 60661, US

(21) Appl. No.: 11/385,423

(22) Filed: Mar. 21, 2006

Related U.S. Application Data
(60) Provisional application No. 60/717,915, filed on Sep. 16, 2005.
(60) Provisional application No. 60/778,232, filed on Mar. 2, 2006.

(51) Int. Cl. H04L 27/08; H04L 27/22

(52) U.S. Cl. 375/345; 375/332

(57) ABSTRACT

Aspects of a method and system for a mobile cellular television tuner utilizing current-steering variable gain at radio frequency are provided. A control signal may be generated in a LNA integrated within a single-chip multi-band RF receiver based on a gain signal. Adjusting a current flow through circuitry in an input stage within the LNA via the control signal may control a gain for the integrated LNA. A replica circuit within the LNA may be utilized to generate the control signal. A transconductor within the LNA may be utilized to convert the gain signal from a voltage to a current for generating the control signal. The gain signal may be generated on-chip or off-chip. A switched capacitor bank within the LNA may be adjusted to control the input scattering parameter. At least one bias voltage within the LNA may be adjusted during operation of the single-chip multi-band RF receiver.

### CROSS-REFERENCE TO RELATED APPLICATIONS/INCORPORATION BY REFERENCE

This application makes reference to, claims priority to, and claims the benefit of:

U.S. Provisional Application Ser. No. 60/717,915 filed on Sep. 16, 2005; and

U.S. Provisional Application Ser. No. 60/778,232 filed on Mar. 2, 2006.

This application also makes reference to:

U.S. application Ser. No. ______ (Attorney Docket No. 17373US02) filed on even date herewith;

U.S. application Ser. No. ______ (Attorney Docket No. 17375US02) filed on even date herewith;

U.S. application Ser. No. ______ (Attorney Docket No. 17376US02) filed on even date herewith;

U.S. application Ser. No. ______ (Attorney Docket No. 17377US02) filed on even date herewith; and

U.S. application Ser. No. ______ (Attorney Docket No. 17378US02) filed on even date herewith.

Each of the above stated applications is hereby incorporated herein by reference in its entirety.

### FIELD OF THE INVENTION

Certain embodiments of the invention relate to on-chip RF tuners. More specifically, certain embodiments of the invention relate to a method and system for a mobile cellular television tuner utilizing current-steering variable gain at radio frequency (RF).

### BACKGROUND OF THE INVENTION

Broadcasting and telecommunications have historically occupied separate fields. In the past, broadcasting was largely an “over-the-air” medium while wired media carried telecommunications. That distinction may no longer apply as both broadcasting and telecommunications may be delivered over either wired or wireless media. Present development may adapt broadcasting to mobility services. One limitation has been that broadcasting may often require high bit rate data transmission at rates higher than could be supported by existing mobile communications networks. However, with emerging developments in wireless communications technology, even this obstacle may be overcome.

Terrestrial television and radio broadcast networks have made use of high power transmitters covering broad service areas, which enable one-way distribution of content to user equipment such as televisions and radios. By contrast, wireless telecommunications networks have made use of low power transmitters, which have covered relatively small areas known as “cells”. Unlike broadcast networks, wireless networks may be adapted to provide two-way interactive services between users of user equipment such as telephones and computer equipment.

The introduction of cellular communications systems in the late 1970's and early 1980's represented a significant advance in mobile communications. The networks of this period may be commonly known as first generation, or “1G” systems. These systems were based upon analog, circuit-switching technology, the most prominent of these systems may have been the advanced mobile phone system (AMPS). Second generation, or “2G” systems ushered improvements in performance over 1G systems and introduced digital technology to mobile communications. Exemplary 2G systems include the global system for mobile communications (GSM), digital AMPS (D-AMPS), and code division multiple access (CDMA). Many of these systems have been designed according to the paradigm of the traditional telephony architecture, often focused on circuit-switched services, voice traffic, and supported data transfer rates up to 14.4 kbits/s. Higher data rates were achieved through the deployment of “2.5G” networks, many of which were adapted to existing 2G network infrastructures. The 2.5G networks began the introduction of packet-switching technology in wireless networks. However, it is the evolution of third generation, or “3G” technology that may introduce fully packet-switched networks, which support high-speed data communications.

Standards for digital television terrestrial broadcasting (DTTB) have evolved around the world with different systems being adopted in different regions. The three leading DTTB systems are, the advanced standards technical committee (ATSC) system, the digital video broadcast terrestrial (DVB-T) system, and the integrated service digital broadcasting terrestrial (ISDB-T) system. The ATSC system has largely been adopted in North America, South America, Taiwan, and South Korea. This system adapts trellis coding and 8-level vestigial sideband (8-VSB) modulation. The DVB-T system has largely been adopted in Europe, the Middle East, Australia, as well as parts of Africa and parts of Asia. The DVB-T system adapts coded orthogonal frequency division multiplexing (COFDM). The OFDM spread spectrum technique may be utilized to distribute information over many carriers that are spaced apart at specified frequencies. The OFDM technique may also be referred to as multi-carrier or discrete multi-tone modulation. This technique may result in spectral efficiency and lower multi-path distortion, for example. The ISDB-T system has been adopted in Japan and adapts bandwidth segmented transmission orthogonal frequency division multiplexing (BST-OFDM). The various DTTB systems may differ in important aspects; some systems employ a 6 MHz channel separation, while others may employ 7 MHz or 8 MHz channel separations.

While 3G systems are evolving to provide integrated voice, multimedia, and data services to mobile user equipment, there may be compelling reasons for adapting DTTB systems for this purpose. One of the more notable reasons may be the high data rates that may be supported in DTTB systems. For example, DVB-T may support data rates of 15 Mbits/s in an 8 MHz channel in a wide area single frequency network (SFN). There are also significant challenges in deploying broadcast services to mobile user equipment. Because of form factor constraints, many handheld portable devices, for example, may require that PCB area be minimized and that services consume minimum power to extend battery life to a level that may be acceptable to users. Another consideration is the Doppler effect in moving user equipment, which may cause inter-symbol interference in received signals. Among the three major DTTB systems, ISDB-T was originally designed to support broadcast services to mobile user equipment. While DVB-T may not have been originally designed to support mobility broadcast services, a number of adaptations have been made to provide support for mobile broadcast capability. The adaptation of DVB-T to mobile broadcasting is commonly known as DVB handheld (DVB-H). The broadcasting frequencies for Europe are in UHF (bands IV/V) and in the US, the 1670-1675 MHz band that has been allocated for DVB-H operation. Additional spectrum is expected to be allocated in the L-band world-wide.

To meet requirements for mobile broadcasting the DVB-H specification supports time slicing to reduce power consumption at the user equipment, addition of a 4K mode to enable network operators to make tradeoffs between the advantages of the 2K mode and those of the 8K mode, and an additional level of forward error correction on multi-protocol encapsulated data—forward error correction (MPE-FEC) to make DVB-H transmissions more robust to the challenges presented by mobile reception of signals and to potential limitations in antenna designs for handheld user equipment. DVB-H may also use the DVB-T modulation schemes, like QPSK and 16-quadrature amplitude modulation (16-QAM).

While several adaptations have been made to provide support for mobile broadcast capabilities in DVB-T, concerns regarding device size, cost, and/or power requirements still remain significant constraints for the implementation of handheld portable devices enabled for digital video broadcasting operations. For example, typical DVB-T tuners or receivers in mobile terminals may employ super-heterodyne architectures with one or two intermediate frequency (IF) stages and direct sampling of the passband signal for digital quadrature down-conversion. Moreover, external tracking and SAW filters may generally be utilized for channel selection and image rejection. Such approaches may result in increased power consumption and high external component count, which may limit their application in handheld portable devices. In this regard, the ability to integrate more functionality into fewer and/or smaller devices may be important in meeting the space and size requirements of many handheld portable devices. As a result, the success of mobile broadcast capability of DVB-T may depend in part on the ability to develop TV tuners with more integrated functionality and that have smaller form factor, are produced at lower cost, and consume less power during operation.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a mobile cellular television tuner utilizing current-steering variable gain at radio frequency (RF), substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram illustrating an exemplary mobile terminal, in accordance with an embodiment of the invention.

FIG. 1B is a block diagram illustrating exemplary communication between a dual-band RF receiver and a digital baseband processor in a mobile terminal, in accordance with an embodiment of the invention.

FIG. 1C is a block diagram illustrating an exemplary single-chip dual-band RF receiver with an integrated LNA in each front-end, in accordance with an embodiment of the invention.

FIG. 1D is a block diagram illustrating an exemplary single-chip dual-band RF receiver with on-chip gain control processing, in accordance with an embodiment of the invention.

FIG. 2 is a flow diagram illustrating exemplary steps in the operation of a single-chip dual-band RF receiver, in accordance with an embodiment of the invention.

FIG. 3 is a schematic diagram illustrating an exemplary integrated variable LNA with replica circuitry, in accordance with an embodiment of the invention.

FIG. 4 is a flow diagram illustrating exemplary steps in the operation of the variable LNA, in accordance with an embodiment of the invention.

### DETAILED DESCRIPTION OF THE INVENTION

Certain embodiments of the invention may be found in a method and system for a mobile cellular television tuner utilizing current-steering variable gain at radio frequency (RF). A control signal may be generated in an LNA integrated within a single-chip multi-band RF receiver based on a gain signal. Adjusting a current flow through circuitry in an input stage within the LNA via the control signal may control a gain for the integrated LNA. A replica circuit within the LNA may be utilized to generate the control signal. A transconductor within the LNA may be utilized to convert the gain signal from a voltage to a current for generating the control signal. The gain signal may be generated on-chip or off-chip. A switched capacitor bank within the LNA may be adjusted to control the input scattering parameter. At least one bias voltage within the LNA may be adjusted during operation of the single-chip multi-band RF receiver.

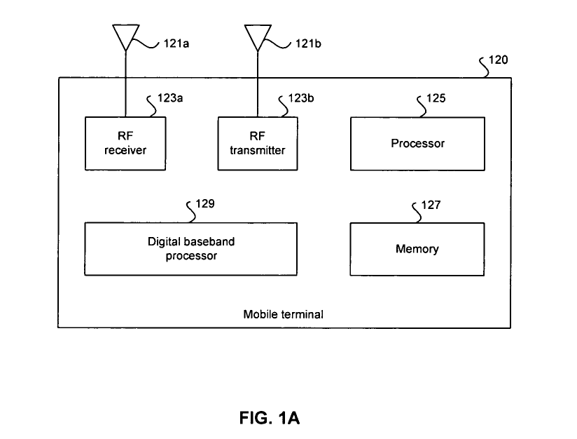

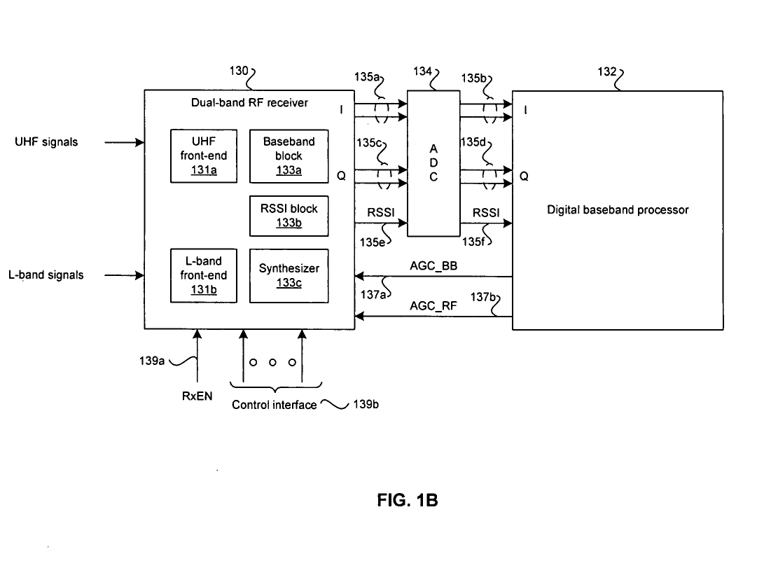

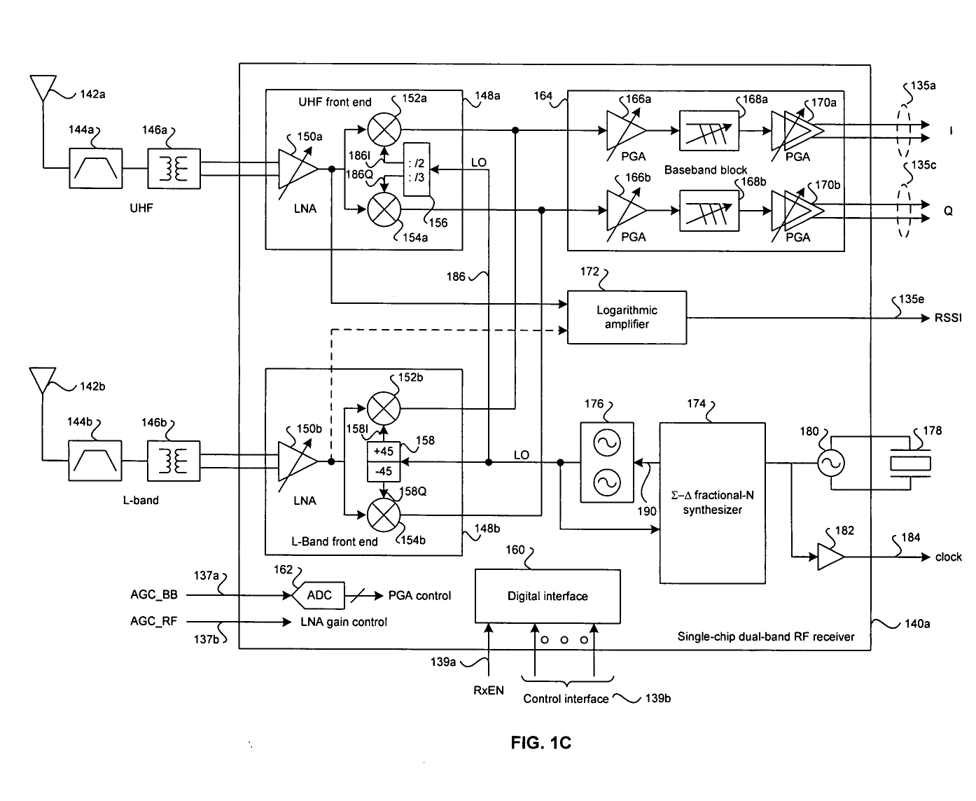

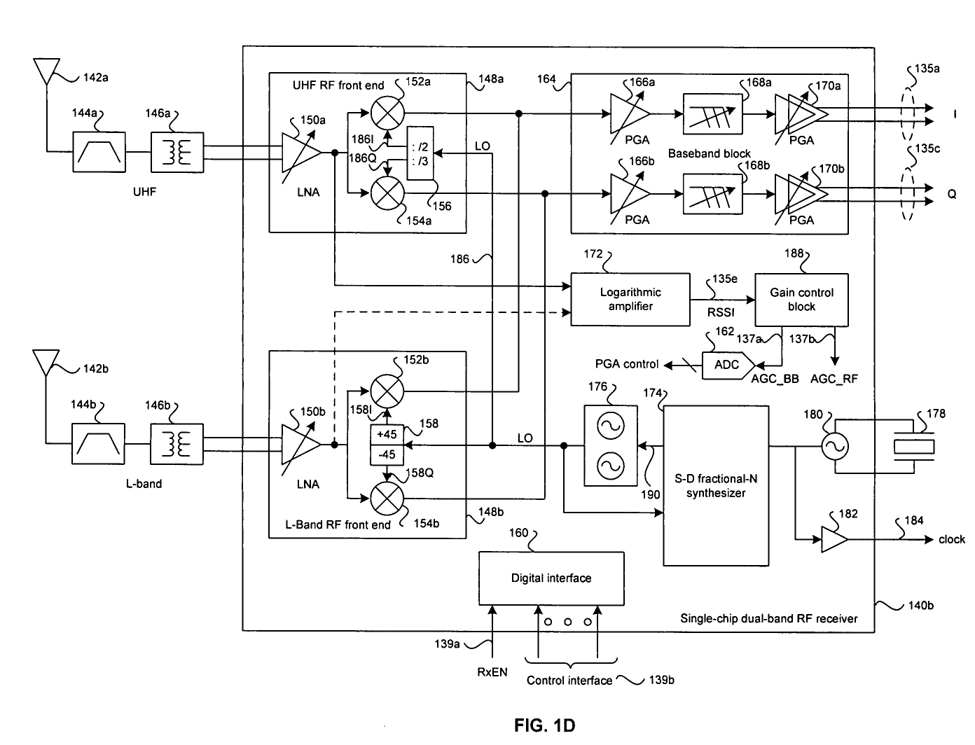

FIG. 1A is a block diagram illustrating an exemplary mobile terminal, in accordance with an embodiment of the invention. Referring to FIG. 1A, there is shown a mobile terminal 120 that may comprise an RF receiver 123a, an RF transmitter 123b, a digital baseband processor 129, a processor 125, and a memory 127. A receive antenna 121a may be communicatively coupled to the RF receiver 123a. A transmit antenna 121b may be communicatively coupled to the RF transmitter 123b. The mobile terminal 120 may be operated in a system, such as the cellular network and/or digital video broadcast network, for example. The U.S. application Ser. No. ______ (Attorney Docket No. 17373US02), filed on even date herewith, discloses a cellular network and/or digital video broadcast network in reference to a method and system for a multi-band direct conversion CMOS mobile cellular television tuner, and is hereby incorporated herein by reference in its entirety.

The RF receiver 123a may comprise suitable logic, circuitry, and/or code that may enable processing of received RF signals. The RF receiver 123a may enable receiving RF signals in a plurality of frequency bands. For example, the RF receiver 123a may enable receiving DVB-H transmission signals via the UHF band, from about 470 MHz to about 890 MHz, the 1670-1675 MHz band, and/or the L-band, from about 1400 MHz to about 1700 MHz, for example. Moreover, the RF receiver 123a may enable receiving signals in cellular frequency bands, for example. Each frequency band supported by the RF receiver 123a may have a corresponding front-end circuit for handling low noise amplification and down conversion operations, for example. In this regard, the RF receiver 123a may be referred to as a multi-band receiver when it supports more than one frequency band. In another embodiment of the invention, the mobile terminal 120 may comprise more than one RF receiver 123a, wherein each of the RF receiver 123a may be a single-band or a multi-band receiver.

The RF receiver 123a may quadrature down convert the received RF signal to a baseband frequency signal that comprises an in-phase (I) component and a quadrature (Q) component. The RF receiver 123a may perform direct down conversion of the received RF signal to a baseband frequency signal, for example. In some instances, the RF receiver 123a may enable analog-to-digital conversion of the baseband signal components before transferring the components to the digital baseband processor 129. In other instances, the RF receiver 123a may transfer the baseband signal components in analog form.

The digital baseband processor 129 may comprise suitable logic, circuitry, and/or code that may enable processing and/or handling of baseband frequency signals. In this regard, the digital baseband processor 129 may process or handle signals received from the RF receiver 123a and/or signals to be transferred to the RF transmitter 123b, when the RF transmitter 123b is present, for transmission to the network. The digital baseband processor 129 may also provide control and/or feedback information to the RF receiver 123a and to the RF transmitter 123b based on information from the processed signals. The digital baseband processor 129 may communicate information and/or data from the processed signals to the processor 125 and/or to the memory 127. Moreover, the digital baseband processor 129 may receive information from the processor 125 and/or to the memory 127, which may be processed and transferred to the RF transmitter 123b for transmission to the network.

The RF transmitter 123b may comprise suitable logic, circuitry, and/or code that may enable processing of RF signals for transmission. The RF transmitter 123b may enable transmission of RF signals in a plurality of frequency bands. Moreover, the RF transmitter 123b may enable transmitting signals in cellular frequency bands, for example. Each frequency band supported by the RF transmitter 123b may have a corresponding front-end circuit for handling amplification and up conversion operations, for example. In this regard, the RF transmitter 123b may be referred to as a multi-band transmitter when it supports more than one frequency band. In another embodiment of the invention, the mobile terminal 120 may comprise more than one RF transmitter 123b, wherein each of the RF transmitter 123b may be a single-band or a multi-band transmitter.

The RF transmitter 123b may quadrature up convert the baseband frequency signal comprising I/Q components to an RF signal. The RF transmitter 123b may perform direct up conversion of the baseband frequency signal to a baseband frequency signal, for example. In some instances, the RF transmitter 123b may enable digital-to-analog conversion of the baseband signal components received from the digital baseband processor 129 before up conversion. In other instances, the RF transmitter 123b may receive baseband signal components in analog form.

The processor 125 may comprise suitable logic, circuitry, and/or code that may enable control and/or data processing operations for the mobile terminal 120. The processor 125 may be utilized to control at least a portion of the RF receiver 123a, the RF transmitter 123b, the digital baseband processor 129, and/or the memory 127. In this regard, the processor 125 may generate at least one signal for controlling operations within the mobile terminal 120. The processor 125 may also enable executing of applications that may be utilized by the mobile terminal 120. For example, the processor 125 may execute applications that may enable displaying and/or interacting with content received via DVB-H transmission signals in the mobile terminal 120.

The memory 127 may comprise suitable logic, circuitry, and/or code that may enable storage of data and/or other information utilized by the mobile terminal 120. For example, the memory 127 may be utilized for storing processed data generated by the digital baseband processor 129 and/or the processor 125. The memory 127 may also be utilized to store information, such as configuration information, that may be utilized to control the operation of at least one block in the mobile terminal 120. For example, the memory 127 may comprise information necessary to configure the RF receiver 123a to enable receiving DVB-H transmission in the appropriate frequency band.

FIG. 1B is a block diagram illustrating exemplary communication between a dual-band RF receiver and a digital baseband processor in a mobile terminal, in accordance with an embodiment of the invention. Referring to FIG. 1B, there is shown a dual-band RF receiver 130, an analog-to-digital converter (ADC) 134, and a digital baseband processor 132. The dual-band RF receiver 130 may comprise a UHF front-end 131a, an L-band front-end 131b, a baseband block 133a, a received signal strength indicator (RSSI) block 133b, and a synthesizer 133c. The dual-band RF receiver 130, the analog-to-digital converter (ADC) 134, and/or the digital baseband processor 132 may be part of a mobile terminal, such as the mobile terminal 120 in FIG. 1A, for example.

The dual-band RF receiver 130 may comprise suitable logic, circuitry, and/or code that may enable handling of UHF and L-band signals. The dual-band RF receiver 130 may be enabled via an enable signal, such as the signal RxEN 139a, for example. In this regard, enabling the dual-band RF receiver 130 via the signal RxEN 139a by a 1:10 ON/OFF ratio may allow time slicing in DVB-H while reducing power consumption. At least a portion of the circuitry within the dual-band RF receiver 130 may be controlled via the control interface 139b. The control interface 139b may receive information from, for example, a processor, such as the processor 125 in FIG. 1A, or from the digital baseband processor 132. The control interface 139b may comprise more than one bit. For example, when implemented as a 2-bit interface, the control interface 139a may be an inter-integrated circuit (I2C) interface.

The UHF front-end 131a may comprise suitable logic, circuitry, and/or code that may enable low noise amplification and direct down conversion of UHF signals. In this regard, the UHF front-end 131a may utilize an integrated low noise amplifier (LNA) and mixers, such as passive mixers, for example. The UHF front-end 131a may communicate the resulting baseband frequency signals to the baseband block 133a for further processing.

The L-band front-end 131b may comprise suitable logic, circuitry, and/or code that may enable low noise amplification and direct down conversion of L-band signals. In this regard, the L-band front-end 131b may utilize an integrated LNA and mixers, such as passive mixers, for example. The L-band front-end 131b may communicate the resulting baseband frequency signals to the baseband block 133a for further processing. The dual-band RF receiver 130 may enable one of the UHF front-end 131a and the L-band front-end 131b based on current communication conditions.

The synthesizer 133c may comprise suitable logic, circuitry, and/or code that may enable generating the appropriate local oscillator (LO) signal for performing direct down conversion in either the UHF front-end 131a or the L-band front-end 131b. Since the synthesizer 133c may enable fractional division of a source frequency when generating the LO signal, a large range of crystal oscillators may be utilized as a frequency source for the synthesizer 133c. This approach may enable the use of an existing crystal oscillator in a mobile terminal PCB, thus reducing the number of external components necessary to support the operations of the dual-band RF receiver 130, for example. The synthesizer 133 may generate a common LO signal for the UHF front-end 131a and for the L-band front-end 131b. In this regard, the UHF front-end 131a and the L-band front-end 131b may enable dividing the LO signal in order to generate the appropriate signal to perform down conversion from the UHF band and from the L-band respectively. In some instances, the synthesizer 133 may have at least one integrated voltage controlled oscillator (VCO) for generating the LO signal. In other instances, the VCO may be implemented outside the synthesizer 133.

The baseband block 133a may comprise suitable logic, circuitry, and/or code that may enable processing of I/Q components generated from the direct down conversion operations in the UHF front-end 131a and the L-band front-end 131b. The baseband block 133a may enable amplification and/or filtering of the I/Q components in analog form. The baseband block 133a may communicate the processed I component, that is, signal 135a, and the processed Q component, that is, signal 135c, to the ADC 134 for digital conversion.

The RSSI block 133b may comprise suitable logic, circuitry, and/or code that may enable measuring the strength, that is, the RSSI value, of a received RF signal, whether UHF or L-band signal. The RSSI measurement may be performed, for example, after the received RF signal is amplified in either the UHF front-end 131a or the L-band front-end 131b. The RSSI block 133b may communicate the analog RSSI measurement, that is, signal 135e, to the ADC 134 for digital conversion.

The ADC 134 may comprise suitable logic, circuitry, and/or code that may enable digital conversion of signals 135a, 135c, and/or 135e to signals 135b, 135d, and/or 135f respectively. In some instances, the ADC 134 may be integrated into the dual-band RF receiver 130 or into the digital baseband processor 132.

The digital baseband processor 132 may comprise suitable logic, circuitry, and/or code that may enable processing and/or handling of baseband frequency signals. In this regard, the digital baseband processor 132 may be the same or substantially similar to the digital baseband processor 129 described in FIG. 1A. The digital baseband processor 132 may enable generating at least one signal, such as the signals AGC_BB 137a and AGC_RF 137b, for adjusting the operations of the dual-band RF receiver 130. For example, the signal AGC_BB 137a may be utilized to adjust the gain provided by the baseband block 133a on the baseband frequency signals generated from either the UHF front-end 131a or the L-band front-end 131b. In another example, the signal AGC_RF 137b may be utilized to adjust the gain provided by an integrated LNA in either the UHF front-end 131a or the L-band front-end 131b. In another example, the digital baseband processor 132 may generate at least one control signal or control information communicated to the dual-band RF receiver 130 via the control interface 139b for adjusting operations within the dual-band RF receiver 130.

FIG. 1C is a block diagram illustrating an exemplary single-chip dual-band RF receiver with an integrated LNA in each front-end, in accordance with an embodiment of the invention. Referring to FIG. 1C, there is shown a single-chip dual-band RF receiver 140a that may comprise a UHF front-end 148a, an L-band front-end 148b, a baseband block 164, a logarithmic amplifier (logarithmic amplifier) 172, a Σ-Δ fractional-N synthesizer 174, a VCO block 176, a digital interface 160, an ADC 162, an oscillator 180, and a buffer 182.

The single-chip dual-band RF receiver 140a may be fabricated using any of a plurality of semiconductor manufacturing processes, for example, complimentary metal-oxide-semiconductor (CMOS) processes, bipolar CMOS (BiCMOS), or Silicon Germanium (SiGe). The single-chip dual-band RF receiver 140a may be implemented using differential structures to minimize noise effects and/or substrate coupling, for example. The single-chip dual-band RF receiver 140a may utilize low drop out (LDO) voltage regulators to regulate and clean up on-chip voltage supplies. In this regard, the LDO voltage regulators may be utilized to transform external voltage sources to the appropriate on-chip voltages.

When the single-chip dual-band RF receiver 140a is implemented utilizing a CMOS process, some design considerations may include achieving low noise figure (NF) values, wide-band operation, high signal-to-noise ration (SNR), performing DC offset removal, achieving high input second-order and third-order intercept points (IIP2 and IIP3), and/or reducing I/Q mismatch, for example.

The single-chip dual-band RF receiver 140a may receive UHF signals via a first antenna 142a, a UHF filter 144a, and a first balum 146a. The UHF filter 144a enables band pass filtering, wherein the band pass may be about 470 to about 702 MHz for cellular signals, for example, or about 470 to about 862 MHz, for other types of received signals, for example. The balum 146a enables balancing the filtered signals before being communicated to the UHF front-end 148a.

The single-chip dual-band RF receiver 140a may receive L-band signals via a second antenna 142b, an L-band filter 144b, and a second balum 146b. The L-band filter 144b enables band pass filtering, wherein the band pass may be about 1670 to about 1675 MHz for signals in US systems, for example, or about 1450 to about 1490 MHz, for signals in European systems, for example. The balum 146b enables balancing the filtered signals before being communicated to the L-band front-end 148a. In some instances, antennas 142a and 142b may be implemented utilizing a single antenna communicatively coupled to the single-chip dual-band RF receiver 140a that may support receiving radio signals operating in the UHF IV/V and/or L-band, for example.

The UHF front-end 148a may comprise a variable low noise amplifier (LNA) 150a, a mixer 152a, a mixer 154a, and a LO signal divider 156. The variable LNA 150a may comprise suitable logic and/or circuitry that may enable amplification of the UHF signals received. Matching between the output of the balum 146a and the input of the variable LNA 150a may be achieved by utilizing off-chip series inductors, for example. The variable LNA 150a may implement continuous gain control by current steering that may be controlled by a replica scheme within the variable LNA 150a. The gain of the variable LNA 150a may be adjusted via the signal AGC_RF 137b, for example.

The mixers 152a and 154a may comprise suitable logic and/or circuitry that may enable generating in-phase (I) and quadrature (Q) components of the baseband frequency signal based on direct down conversion of the amplified received UHF signal with the quadrature signals 186I and 186Q generated by the divider block 156. The mixers 152a and 154a may be passive mixers in order to achieve high linearity and/or low flicker noise, for example. The LO signal divider 156 may comprise suitable logic, circuitry, and/or code that may enable dividing of the LO signal 186 by a factor of 2 (:/2) or a factor of 3 (:/3) and at the same time provide quadrature outputs 186I and 186Q, wherein 186I and 186Q have 90 degrees separation between them. The factor of 3 division may be used when the received UHF signal band is about 470 to about 600 MHz, for example. The factor of 2 division may be used when the received UHF signal band is about 600 to about 900 MHz, for example. The I/Q components generated by the mixers 152a and 154a may be communicated to the baseband block 164.

The L-band front-end 148b may comprise a variable LNA 150b, a mixer 152a, a mixer 154a, and a LO signal generator 158. The variable LNA 150a may comprise suitable logic and/or circuitry that may enable amplification of the L-band signals received. Matching between the output of the balum 146b and the input of the variable LNA 150b may be achieved by utilizing off-chip series inductors, for example. The variable LNA 150b may implement continuous gain control by current steering that may be controlled by a replica scheme within the variable LNA 150b. The gain of the variable LNA 150b may be adjusted via the signal AGC_RF 137b, for example.

The mixers 152b and 154b may comprise suitable logic and/or circuitry that may enable generating I/Q components of the baseband frequency signal based on the direct down conversion of the amplified received L-band signal with the LO signals 1581 and 158Q generated by the LO generator block 158. The mixers 152b and 154b may be passive mixers in order to achieve high linearity and/or low flicker noise, for example. The LO signal generator 158 may comprise suitable logic, circuitry, and/or code that may enable generation of quadrature LO signals 158I and 158Q, that is, signals with 90 degree phase split between them, from the LO signal 186. The I/Q components generated by the mixers 152b and 154b may be communicated to the baseband block 164.

The logarithmic amplifier 172 may comprise suitable logic, circuitry, and/or code that may enable generation of a wideband, received signal strength indicator (RSSI) signal, such as the signal 135e, based on the output of the variable LNA 150a. The RSSI signal indicates the total amount of signal power that is present at the output of the LNA, for example. The RSSI signal may be utilized by, for example, the digital baseband processor 132 in FIG. 1B, to adjust the gain of the variable LNA 150a in the presence of RF interference to achieve NF and/or linearity performance that meets blocking and/or intermodulation specifications, for example. In this regard, interference may refer to blocker signals, for example. Blocker signals may be unwanted signals in frequency channels outside the wanted or desired channel that may disturb the reception of the wanted signals. This effect may be a result of blockers generating large signals within the receiver path. These large signals may introduce harmonics, intermodulation products, and/or unwanted mixing products that crosstalk with the wanted signals. In another embodiment of the invention, the logarithmic amplifier 172 may enable generating a wideband, RSSI signal, such as the signal 135e, based on the output of the variable LNA 150b. In this instance, the RSSI signal may be utilized by to adjust the gain of the variable LNA 150b.

The baseband block 164 may comprise an in-phase component processing path and a quadrature component processing path. The in-phase processing path may comprise at least one programmable gain amplifier (PGA) 166a, a baseband filter 168a, and at least one PGA 170a. The quadrature component processing path may comprise at least one PGA 166b, a baseband filter 168b, and at least one PGA 170b. The PGAs 166a, 166b, 170a, and 170b may comprise suitable logic, circuitry, and/or code that may enable amplification of the down converted components of the baseband frequency signal generated by the RF front-end. The gain of the PGAs 166a, 166b, 170a, and 170b may be digitally programmable. In addition, at the output of the PGAs 166a and 166b, a programmable pole may be utilized to reduce linearity requirements for the baseband filters 168a and 168b respectively. Since the static and time-varying DC offset may saturate the operation of the single-chip dual-band RF receiver 140a, the PGAs 166a, 166b, 170a, and 170b may utilize DC servo loops to address DC offset issues. The gain of the PGAs 166a, 166b, 170a, and/or 170b may be controlled via the AGC_BB signal 137a, for example. In this regard, the ADC 162 may be utilized to provide digital control of the PGAs 166a, 166b, 170a, and/or 170b when the AGC_BB signal 137a is an analog signal.

The baseband filters 168a and 168b may comprise suitable logic, circuitry, and/or code that may enable channel selection, for example. Channel selection may be performed by filters, such as an N^{th} order lowpass Chebyschev filter implemented by active integrators in a leapfrog configuration, for example. For the correct tuning of the characteristics of the filters, an on-chip auto-calibration loop may be activated upon power-up. The auto-calibration loop may set up the corner frequency to the correct vale required to meet the requirements of the communications standard for which the receiver is designed. For DVB-T/DVB-H, the value fₒ of the filter response may be set to a value from 2 to 5 MHz thus supporting the different channel bandwidths of 5-8 MHz specified by DVB-T/DVB-H standards. During auto-calibration, a tone at the appropriate f_{-3dB} may be generated on-chip and may be applied at the input of the baseband filters 168a and 168b for comparison with the filter output of a root-mean-squared (RMS) detector. A digitally controlled loop may be utilized to adjust the baseband filter bandwidth until the output of the baseband filter and the RMS detector are the same.

The Σ-Δ fractional-N synthesizer 174 may comprise suitable logic, circuitry, and/or code that may enable LO generation that may be independent of the reference crystal frequency, such as the crystal 178, for example. In this regard, the synthesizer 174 may generate a signal, such as the signal 190, for example, to control the operation of the VCO block 176 and therefore the generation of the LO signal 186. Since the synthesizer 174 may enable fractional synthesis, the single-chip dual band RF receiver 140a may utilize the same crystal utilized by other operations in the mobile terminal while maintaining fine tuning capability. The synthesizer 174 may receive a reference frequency signal from the crystal 178 via an oscillator 180, for example. The output of the oscillator 180 may also be buffered by the buffer 182 to generate a clock signal 184, for example.

The VCO block 176 may comprise suitable logic, circuitry, and/or code that may enable generating the LO signal 186 utilized by the UHF front-end 148a and the L-band front-end 148b for direct down conversion of the received RF signals. The VCO block 176 may comprise at least one VCO, wherein each VCO may have cross-coupled NMOS and PMOS devices and metal-oxide-semiconductor (MOS) varactors in an accumulation mode for tuning. In this regard, a switched varactor bank may be utilized for providing coarse tuning. The VCO block 176 may provide a range of about 1.2 to about 1.8 GHz when implemented utilizing two VCOs, for example. When more than one VCO is utilized in implementing the VCO block 176, selecting the proper VCO for generating the LO signal 186 may be based on the type of RF signal being received by the single-chip dual band RF receiver 140a.

The digital interface 160 may comprise suitable logic, circuitry, and/or code that may enable controlling circuitry within the single-chip dual band RF receiver 140a. The digital interface 160 may comprise a plurality of registers for storing control and/or operational information for use by the single-chip dual-band RF receiver 140a. The digital interface 160 may enable receiving the signal RxEN 139a that may be utilized to perform 1:10 ON/OFF ratio time slicing in DVB-H while reducing power consumption. Moreover, the digital interface 160 may enable receiving the control interface 139b from, for example, a processor, such as the processor 125 in FIG. 1A, or from the digital baseband processor 132 in FIG. 1B. The control interface 139b may comprise more than one bit. The control interface 139b may be utilized to control the synthesis operations of the synthesizer 174 and/or the filtering operations of the baseband filters 168a and 168b. The control interface 139b may also be utilized to adjust the bias of circuits within the single-chip dual-band RF receiver 140a, such as those of the variable LNAs 150a and 150b, the PGAs 166a, 166b, 170a, and 170b, and/or the baseband filters 168a and 168b, for example.

FIG. 1D is a block diagram illustrating an exemplary single-chip dual-band RF receiver with on-chip gain control processing, in accordance with an embodiment of the invention. Referring to FIG. 1D, there is shown a single-chip dual-band RF receiver 140b that may differ from the single-chip dual-band RF receiver 140a in FIG. 1C in that a gain control block 186 may be integrated into the single-chip dual-band RF receiver 140b. The gain control block 186 may comprise suitable logic, circuitry, and/or code that may enable on-chip gain adjustment for the variable LNAs 150a and 150b and for the PGAs 166a, 166b, 170a, and 170b. In this regard, the gain control block 186 may receive the RSSI signal 135e and may generate the signals AGC_BB 137a and AGC_RF 137b, for example.

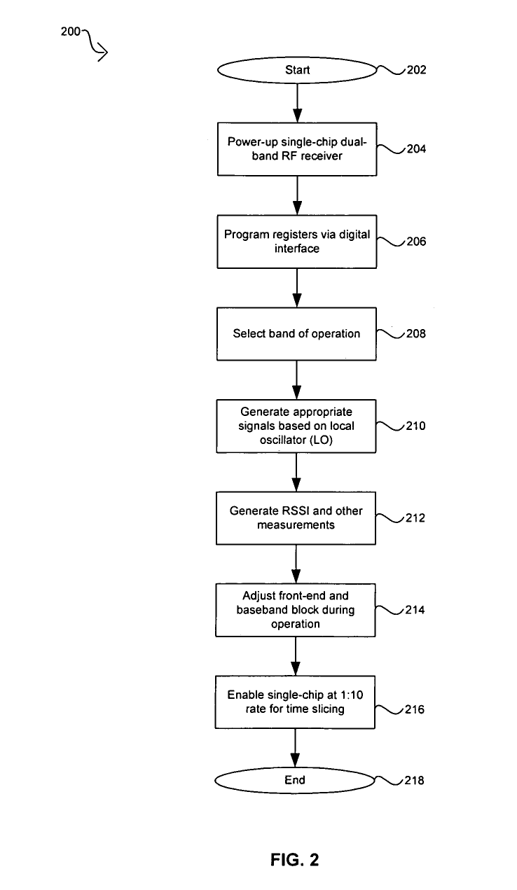

FIG. 2 is a flow diagram illustrating exemplary steps in the operation of a single-chip dual-band RF receiver, in accordance with an embodiment of the invention. Referring to FIG. 2, there is shown a flow diagram 200. In step 204, after start step 202, a single-chip dual-band RF receiver, such as the single-chip dual-band RF receiver 140a and 140b, for example, may be powered up in a mobile terminal. In step 206, the RF receiver may be enabled via signal RxEN 139a and control and/or operational information may be programmed into the digital interface 160 via the control interface 139b for use by the RF receiver during operation.

In step 208, an operating frequency band may be selected via the control interface 139b. In this regard, if the mobile terminal is to receive UHF signals, the UHF front-end 152a, the baseband block 164, and/or the synthesizer 174 may be configured for receiving and processing UHF signals in the RF receiver. If the mobile terminal is to receive L-band signals, the L-band front-end 152b, the baseband block 164, and/or the synthesizer 174 may be configured for receiving and processing L-band signals in the RF receiver. In step 210, the synthesizer 174 and the VCO block 176 may be utilized to generate the appropriate value for the LO signal 186 base on the band of operation.

In step 214, the RF receiver may measure an RSSI for the output of the variable LNA of the currently operating front-end for determining the amount of adjusting or backing off that may be required from the variable LNA. The amount of adjusting may be determined off-chip or on-chip as described in FIGS. 1D and 1E respectively. Other measurements may be performed in the front-end circuits 148a and 148b and/or the baseband block 164 that may be utilized to adjust biasing levels within the RF receiver. In step 216, the front-end circuits 148a and 148b and/or the baseband block 164 may be adjusted, when necessary, based on measurements performed in step 214. In step 216, during DVB-H operation, the RF receiver may be enabled utilizing a 1:10 ON/OFF ratio for time slicing in DVB-H and to reduce power consumption. After step 216, the process may proceed to end step 218.

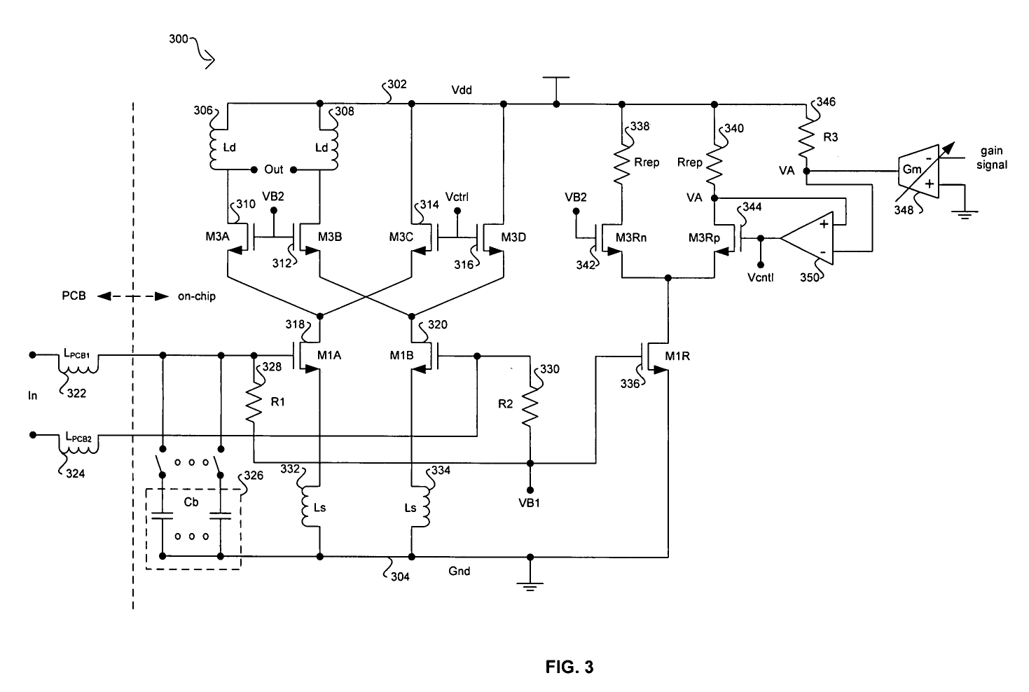

FIG. 3 is a schematic diagram illustrating an exemplary integrated variable LNA with replica circuitry, in accordance with an embodiment of the invention. Referring to FIG. 3, there is shown an LNA 300 that may be integrated within front-end circuitry in the single-chip dual-band RF receivers 140a and 140b in FIGS. 1C and 1D respectively. In this regard, the LNA 300 may correspond to, for example, the LNA 150a and the LNA 150b integrated within the UHF RF front-end 148a and the L-band RF front-end 148b, respectively. The operation of the LNA 300 may require the use of a voltage supply (Vdd) 302, a ground (Gnd) 304, and bias voltages VB1 and VB2.

The LNA 300 may comprise inductors Ld 306, Ld 308, Ls 332, and Ls 334, transistors M3A 310, M3B 312, M1A 318, M1B 320, M3C 314, and M3D 316, resistors R1 328 and R2 330, and a switched capacitor bank Cb 326. The transistors M3A 310 and M3B 312 may be matched to each other, that is, may be of the same size, the transistors M3C 314 and M3D 316 may be matched to each other, and the transistors M1A 318 and M1B 320 may also be matched to each other. Portions of the LNA 300 associated with the operations of the differential input transistors M1A 318 and M1B 320 may correspond to an input stage of the LNA 300.

The LNA 300 may communicate with PCB components, such as the balums 146a or 146b illustrated in FIG. 1C, via PCB traces that comprise series inductive components L_{PCB1} 322 and L_{PCB2} 324, for example. In this regard, impedance matching between the LNA 300 and the PCB components may be implemented via inductor degeneration techniques that utilize the inductors Ls 332 and Ls 334 in the LNA 300. However, the invention need not be so limited and other types of impedance matching techniques may be utilized for matching the input of the LNA 300 to components on the PCB in a mobile terminal. The switched capacitor bank Cb 326 may comprise a plurality of capacitors wherein the appropriate capacitance value selected for the Cb 326 may be such that high-frequency reflections as measured by, for example, the S11 scattering parameter, may be maintained below a level specified by system and/or design requirements.

The LNA 300 may also comprise circuitry that replicates or mimics the operations of the input stage for providing adjustments to the input state during operations. Portions of the LNA 300 that may be utilized to replicate or mimic the operations of the input stage may be referred to as a replica circuit. In this regard, the LNA 300 may comprise resistors Rrep 338, Rrep 340, and transistors M3Rn 342, M3Rp 344, and M1R 336. The sizes of transistors M3Rn 342, M3Rp 344, and M1R 336 may be scaled down versions of the sizes of the transistors M3A 310, M3B 312, and M1B 320 in the input stage. As a result, the sizes of the transistors M3Rn 342 and M3Rp 344 may be matched to each other.

The replica circuit may be utilized to adjust current steering operations of the input stage of the LNA 300. In this regard, the replica circuit may be utilized to compensate for changes in process and/or operating temperature, and may also be utilized to adjust the gain of the input stage based on a gain signal, such as the signal AGC_RF 137b described in FIGS. 1C and 1D. In this regard, the LNA 300 may also comprise a transconductor 348, a resistor R3 346, and an operational amplifier (op-amp) 350. The transconductor 348 may comprise suitable logic and/or circuitry that may enable conversion of the gain signal to a proportional current based on the transconductance Gm associated with the transconductor 348. The value of Gm may be programmable in order to enable the transconductor 348 to program the gain control slope provided by the gain signal. For example, programmability of the transconductor 348 may enable the LNA 300 to achieve linear-in-dB range of 20 dB in some instances. The op-amp 350 may comprise suitable logic and/or circuitry that may enable a large gain for a differential input. In this regard, the op-amp 350 may provide high input impedance to input signals while maintaining the input signals at substantially the same potential or voltage, that is, VA.

In operation, the values of the bias voltages VB2 and VB1, and the initial value of the gain signal may be applied to the LNA 300. The bias voltage VB1 may enable setting the operating biasing conditions for the differential input transistors M1A 318 and M1B 320 in the input stage via the resistors R1 328 and R2 330 respectively. The bias voltage VB1 may also enable setting the operating biasing conditions for the transistor M1R 336 associated with the replica circuit. The bias voltage VB2 may enable setting the operating biasing conditions for transistors M3A 310 and M3B 312 associated with the input stage and for transistor M3Rn 342 associated with the replica circuit.

The current flowing through transistor M1A 318 may result from the addition of the currents flowing through transistors M3A 310 and M3C 314. In this regard, the control signal, Vcntl, generated at the output of the op-amp 350 may be utilized to control the operating biasing conditions for transistors M3C 314 and M3D 316. As a result, the amount of current flowing through transistor M3C 314, and therefore through transistor M1A 318, may be controlled by the control signal, Vcntl. Similarly, current flowing through transistor M1B 320 may result from the addition of the currents flowing through transistors M3B 3102 and M3D 3146. In this regard, the amount of current flowing through transistor M3D 316, and therefore through transistor M1B 320, may be controlled by the control signal, Vcntl.

The differential input signal, In, may be received by the differential input transistors M1A 318 and M1B 320 to generate a differential output signal, Out, across the inductors Ld 306 and Ld 308. A differential output signal may result when the differential input signal produces variations or differences in the currents flowing through the transistors M1A 318 and M1B 320. The currents flowing through transistors M3C 314 and M3D 316 may be determined by the control signal, Vcntl. When the control signal, Vcntl, remains constant, the currents flowing through transistors M3C 314 and M3D 316 may also remain constant.

When the differential input signal, In, is zero, for example, the currents flowing through the transistors M1A 318 and M1B 320 are the same. As a result, the currents flowing through inductors Ld 306 and Ld 308 are also the same and the differential output signal, Out, is zero. In another example, when the differential input signal, In, is non-zero, the currents flowing through the transistors M1A 318 and M1B 320 are different. As a result, the currents flowing through inductors Ld 306 and Ld 308 are different and the differential output signal, Out, is non-zero. In this instance, a ratio between the differential output signal, Out, and the differential input signal, In, may correspond to the current gain of the LNA 300.

When the gain signal, such as the signal AGC_RF 137b, is changed to adjust the operation of the LNA 300, the currents flowing through the inductors Ld 306 and Ld 308 may be increased or decreased for a differential input signal, In, in order to increase or decrease the gain of the LNA 300 from the current gain provided by the initial gain signal setting. For example, an increase in the gain signal value may result in an increase in the current sinked by the transconductor 348. The increased current may result in a larger voltage drop across resistor R3 346 and therefore a reduction in value of the voltage VA. Since the op-amp 350 enables both inputs to be at substantially the same potential, the voltage drop across resistor R3 346 may be the same voltage drop as across resistor Rrep 340. A reduction in value of the potential VA may result in an increase in value of the control signal, Vcntl, at the gate of the transistor M3Rp 344, for example. The change in value of the control signal, Vcntl, may be reflected at the gate of transistors M3C 314 and M3D 316, where a higher gate voltage may result in an increase in the currents flowing through transistors M3C 314 and M3D 316. As a result, less current may flow through the inductors Ld 306 and Ld 308 and the differential output signal, Out, may be decreased producing a gain decrease for the LNA 300.

In another example, a decrease in the gain signal value may result in a decrease in the current sinked by the transconductor 348. The reduced current may result in a smaller voltage drop across resistor R3 346 and therefore an increase in value of the voltage VA. Since the op-amp 350 enables both inputs to be at substantially the same potential, the voltage drop across resistor R3 346 may be the same voltage drop as across resistor Rrep 340. An increase in value of the potential VA may result in a reduction in value of the control signal, Vcntl, at the gate of the transistor M3Rp 344, for example. The change in value of the control signal, Vcntl, may be reflected at the gate of transistors M3C 314 and M3D 316, where a lower gate voltage may result in a decrease in the currents flowing through transistors M3C 314 and M3D 316. As a result, the current flow through the inductors Ld 306 and Ld 308 may be increased and the differential output signal, Out, may be increased producing a gain increase for the LNA 300. Aspects of the operation of the LNA 300 need not be limited to the examples described above. Moreover, bias voltages VB1 and/or VB2, and/or the transconductance Gm of the transconductor 348 may also be adjusted to control the operations of the LNA 300, for example.

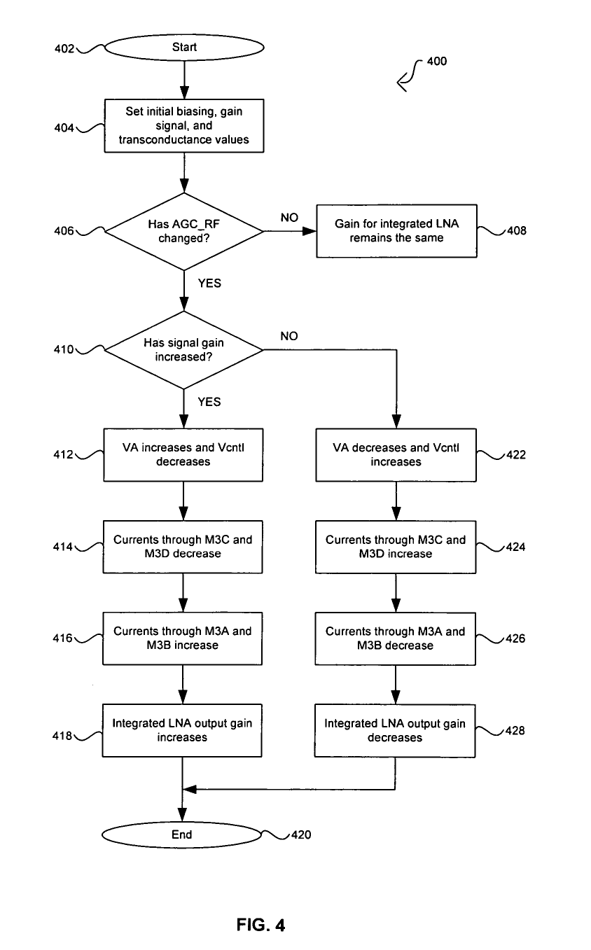

FIG. 4 is a flow diagram illustrating exemplary steps in the operation of the variable LNA, in accordance with an embodiment of the invention. Referring to FIG. 4, there is shown a flow chart 400. In step 404, after start step 402, initial settings for bias voltages VB1 and VB2, for the transconductance Gm, and/or for the gain signal to the LNA 300 in FIG. 3 may be set. In this regard, the gain signal may be generated on-chip or off-chip and the control interface 139b in FIG. 1C may be utilized to program appropriate values for the operation of the LNA 300. In step 406, when the gain signal is not changed or adjusted, the process may proceed to step 408 where the gain for the LNA 300 may remain the same as the current gain. When the gain signal is adjusted, the process may proceed to step 410. In step 410, when the gain signal to the transconductor 348 is increased, the process may proceed to step 412.

In step 412, the value of VA increases and the control signal, Vcntl, decreases with an increase in the current sinked by the transconductor 348. In step 414, the currents flowing through transistors M3C 314 and M3D 316 may decrease with a reduction in Vcntl. In step 416, the currents flowing through M3A 310 and M3B 312 increase since the contribution by transistors M3C 314 and M3D 316 to the currents flowing through the transistors M1A 318 and M1B 320, respectively, are reduced. In step 418, an increase in the currents flowing through M3A 310 and M3B 312 may result in an increase in the differential output signal, Out, and therefore in the overall gain of the LNA 300.

Returning to 410, when the gain signal to the transconductor 348 is reduced, the process may proceed to step 422. In step 422, the value of VA decreases and the control signal, Vcntl, increases with a decrease in the current sinked by the transconductor 348. In step 424, the currents flowing through transistors M3C 314 and M3D 316 may increase with an increase in Vcntl. In step 426, the currents flowing through M3A 310 and M3B 312 decrease since the contribution by transistors M3C 314 and M3D 316 to the currents flowing through the transistors M1A 318 and M1B 320, respectively, are increased. In step 428, a decrease in the currents flowing through M3A 310 and M3B 312 may result in a decrease in the differential output signal, Out, and therefore in the overall gain of the LNA 300. Aspects of the operation of the LNA 300 need not be limited to the exemplary steps described above.

It should be recognized that although a single-chip dual-band RF receiver is illustrated, for example in FIG. 1D, the invention is not limited in this regard. Accordingly, the principles disclosed may be applied to a single-chip n-band RF receiver, where n is greater than 2. For example, coverage for a third band may be provided utilizing a single-chip tri-band RF receiver. Furthermore, coverage for a fourth band may be provided utilizing a single-chip quad-band RF receiver, and so on.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing wireless information, the method comprising:
generating, based on a gain signal, a control signal in a low noise amplifier (LNA) integrated within a single-chip multi-band RF receiver that handles at least L-band frequencies and a UHF band; and
adjusting a current flow through circuitry in an input stage within said integrated LNA based on said generated control signal to control a gain for said integrated LNA.

2. The method according to claim 1, comprising generating said control signal via circuitry within said integrated LNA.

3. The method according to claim 1, comprising reducing said gain for said integrated LNA based on said gain signal.

4. The method according to claim 1, comprising increasing said gain for said integrated LNA based on said gain signal.

5. The method according to claim 1, comprising converting said gain signal to a current via a transcoductor within said integrated LNA for said generating of said control signal.

6. The method according to claim 1, comprising adjusting a switch capacitor bank within said integrated LNA.

7. The method according to claim 1, comprising adjusting at least one bias voltage within said integrated LNA.

8. The method according to claim 7, wherein said at least one bias voltage is generated within said single-chip multi-band RF receiver.

9. The method according to claim 1, wherein said gain signal is generated within said single-chip multi-band RF receiver.

10. The method according to claim 1, wherein said gain signal is generated externally to said single-chip multi-band RF receiver.

11. A system for processing wireless information, the system comprising:
a low noise amplifier (LNA) that enables generating a control signal based on a gain signal, wherein said LNA is integrated within a single-chip multi-band RF receiver that handles at least L-band frequencies and a UHF band; and
said integrated LNA enables adjusting a current flow through circuitry in an input stage within said integrated LNA based on said generated control signal to control a gain for said integrated LNA.

12. The system according to claim 1, wherein said integrated LNA enables generating said control signal via circuitry within said integrated LNA.

13. The system according to claim 1, wherein said integrated LNA enables reducing said gain for said integrated LNA based on said gain signal.

14. The system according to claim 1, wherein said integrated LNA enables increasing said gain for said integrated LNA based on said gain signal.

15. The system according to claim 1, wherein said integrated LNA enables converting said gain signal to a current via a transcoductor within said integrated LNA for said generating of said control signal.

16. The system according to claim 1, wherein said integrated LNA enables adjusting a switch capacitor bank within said integrated LNA.

17. The system according to claim 1, wherein said integrated LNA enables adjusting at least one bias voltage within said integrated LNA.

18. The system according to claim 7, wherein said at least one bias voltage is generated within said single-chip multi-band RF receiver.

19. The system according to claim 1, wherein said gain signal is generated within said single-chip multi-band RF receiver.

20. The system according to claim 1, wherein said gain signal is generated externally to said single-chip multi-band RF receiver.
